(19) United States
(12) Patent Application Publication
(10) Pub. No.: US 2026/0077566 A1
(43) Pub. Date: Mar. 19, 2026

(54) Pneumatic Glove Break-In Apparatus

(71) Applicant: Erik Weinhold, Agoura Hills, CA (US)

(72) Inventor: Erik Weinhold, Agoura Hills, CA (US)

(21) Appl. No.: 18/885,718

(22) Filed: Sep. 15, 2024

(51) Int. Cl. B30B 1/12; A63B 71/14; B30B 1/00

(52) U.S. Cl. CPC B30B 1/12; B30B 1/007; A63B 71/143

(57) ABSTRACT

An apparatus for breaking in baseball and softball gloves comprises a chassis, a glove forming assembly, a pneumatic reciprocating platen press, and a pneumatic foot pedal valve. The glove forming assembly includes an adjustable round base for positioning the glove. The pneumatic press, installed on the chassis above the glove forming assembly, features an upper platen with an interchangeable press head for imparting a desired shape to the glove. The pneumatic foot pedal valve, operably connected to the press, actuates the upper platen to converge and apply pressure when depressed, and retract when released. The apparatus provides an efficient, consistent, and hands-free solution for breaking in gloves, accommodating various glove sizes and shapes. The interchangeable, lightweight design of the apparatus, press heads, adjustable base, and compatibility with standard air compressors make the apparatus versatile and suitable for use by players, teams, and manufacturers.

### BACKGROUND OF THE INVENTION

### Field of the Invention

The various aspects discussed herein relate to an apparatus for breaking in baseball and softball gloves.

### Description of Related Art

Conventional Baseball and softball gloves are essential pieces of equipment for players, but new gloves are often stiff and difficult to use effectively. Conventional methods for breaking in gloves, such as manually bending and shaping the glove or applying oils and creams, can be time-consuming and labor-intensive, often requiring days or even weeks to achieve a satisfactory level of break-in.

In addition, these manual methods may not provide consistent results and can potentially damage the glove if not done properly. Players, coaches, and teams often struggle with the lengthy and challenging process of breaking in multiple new gloves each season.

Moreover, existing glove break-in devices are often large and heavy, making them difficult to transport and use in various settings. A compact and lightweight glove break-in apparatus would enable players, coaches, and teams to easily break in gloves at home, in sporting goods stores, or even on the field, providing a convenient and efficient solution to this common problem.

Accordingly, there is a need in the art for an apparatus that can efficiently and effectively break in baseball and softball gloves, reducing the time and effort required while providing consistent results without damaging the gloves. Such an apparatus would be particularly beneficial for use by individual players, sporting goods stores, glove manufacturers, and teams or organizations that need to regularly break in a large number of gloves.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure provides an apparatus for efficiently and effectively breaking in baseball and softball gloves. In one embodiment, the apparatus includes a chassis formed from tubular metal, a glove forming assembly mounted to the chassis, a pneumatic reciprocating platen press installed on top of the chassis, and a pneumatic foot pedal valve operably connected to the pneumatic press for actuation.

The glove forming assembly comprises an adjustable round base configured to receive and position a glove. The pneumatic press includes an upper platen that converges vertically toward the adjustable round base to apply pressure to the glove when actuated. Advantageously, the upper platen features an interchangeable press head adapted to impart a desired shape to the glove, such as a curved shape using a baseball head or a flattened shape using a metal plate head.

In operation, the pneumatic foot pedal valve causes the upper platen to converge and apply pressure to the glove when depressed, and causes retraction when released. This configuration allows for hands-free operation and easy control of the glove break-in process.

The apparatus may further include a glove pad positionable on the adjustable round base to support the glove. In certain embodiments, the chassis is coated with a durable powder coating and the tubular metal is aluminum or steel.

In contrast to time-consuming and inconsistent manual glove break-in methods, the present apparatus provides a fast, efficient, and repeatable solution. By allowing the user to position the glove, apply a consistent pressure, and shape the glove as desired, the apparatus achieves a high-quality break-in with minimal effort.

The break-in apparatus is highly versatile, featuring an adjustable base that accommodates different glove sizes and shapes. The pneumatic press is compatible with standard shop air compressors. These features make the apparatus ideal for use by players, coaches, teams, sporting goods stores, and glove manufacturers.

The foregoing and other aspects, features, and advantages of the glove break-in apparatus will be apparent from the following detailed description of the preferred embodiments, which makes reference to the several figures of the drawing.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a perspective view of a glove break-in apparatus, according to one embodiment of the present invention.

FIG. 2 is a perspective view of the apparatus with a baseball attached to an upper platen in an elevated position and a glove disposed on an adjustable round base beneath the upper platen, according to one embodiment of the present invention.

FIG. 3 is a perspective view of the apparatus with the baseball attached to the upper platen in a depressed or lowered position, wherein the baseball is depressing into a mitt pocket of the glove, according to one embodiment of the present invention.

FIG. 4 depicts flow diagram detailing the operation of the glove break in apparatus, according to one embodiment of the present invention.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

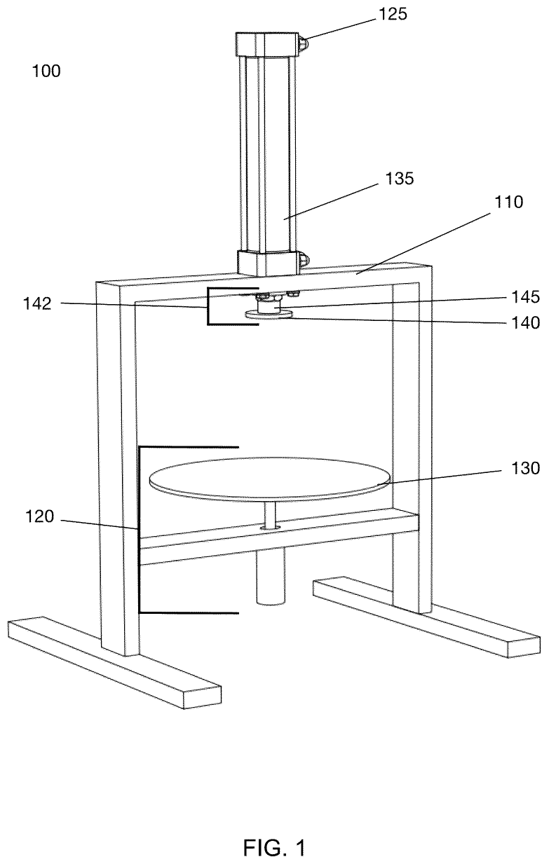

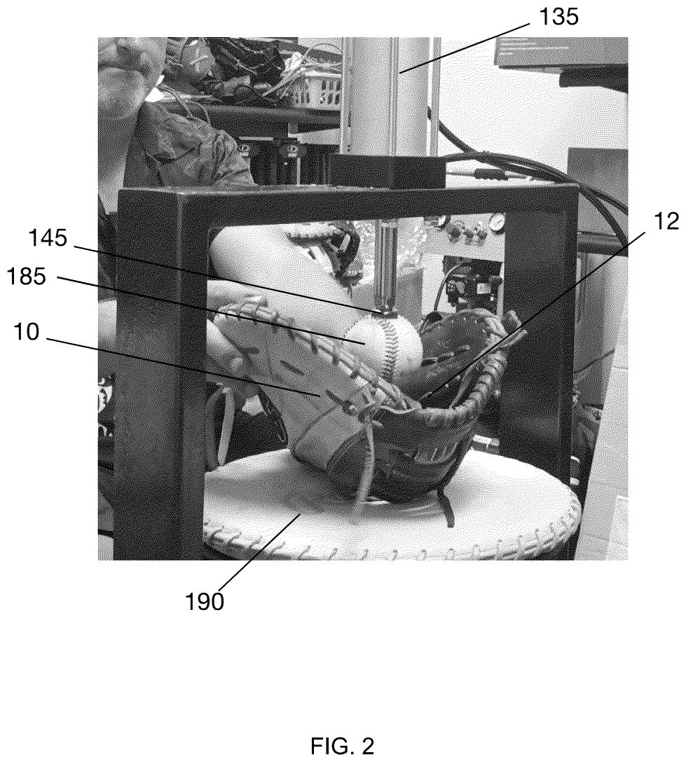

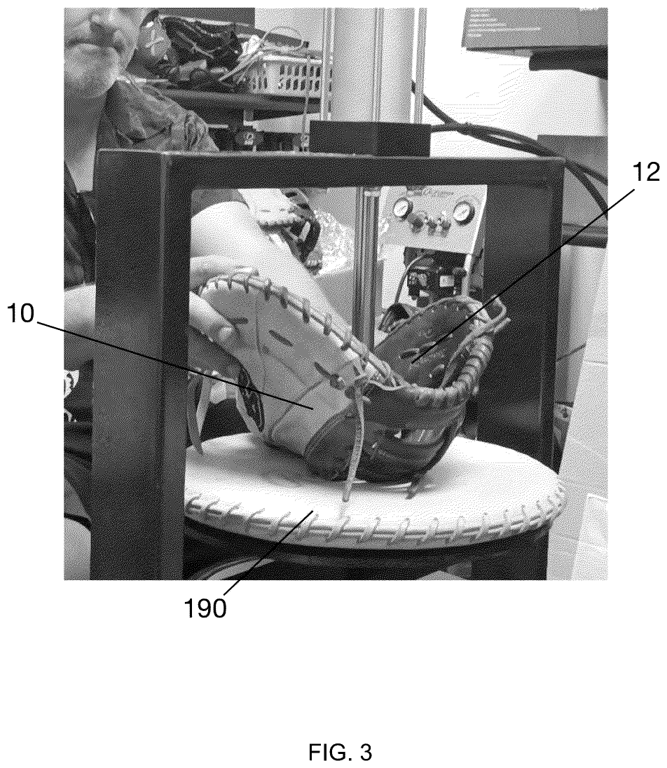

FIG. 1 is a perspective view of a glove break-in apparatus 100. FIG. 2 is a perspective view of the apparatus 100 with a baseball 185 attached to an upper platen 142 in an elevated position and a glove 10 disposed on an adjustable round base 130 beneath the upper platen 140. FIG. 3 is a perspective view of the apparatus 100 with the baseball 185 attached to the upper platen 142 in a depressed or lowered position, wherein the baseball 185 is depressing into a mitt pocket 12 of the glove 10. A glove pad 190 is positioned on the adjustable round base 130 beneath the glove 10, thereby preventing damage to the glove 10 during the break-in process.

With reference to FIGS. 1-3, the glove break-in apparatus 100 comprises a chassis 110 formed from a tubular metal selected from the group comprising aluminum and steel. A glove forming assembly 120 is mounted to the chassis 110 and includes the adjustable round base 130 that is configured to receive and position the glove 10. In one embodiment, the adjustable round base 130 is rotatable and vertically adjustable up to about 4-5 inches to accommodate different sizes and shapes of gloves, thereby providing flexibility to properly position various glove sizes.

In another embodiment, a pneumatic reciprocating platen press 135 is installed on top of the chassis 110 and positioned above the glove forming assembly 120. The pneumatic press 135 can be coupled to a 120V air compressor (not shown) via a connector 125 for attaching an air compressor hose, wherein the apparatus remains passive until connected to an air compressor for operation. The pneumatic press 135 includes the upper platen 142 that is configured to converge vertically toward the adjustable round base 130 and apply pressure to the glove 10 when the press 135 is actuated. In some embodiments, the upper platen 142 includes an interchangeable press head 145 adapted to impart a desired shape to the glove 10.

In one embodiment, the interchangeable press head 145 comprises the baseball 185 configured to impart a curved shape to the glove 10, or alternatively, a metal plate 140 configured to impart a flattened shape. The baseball 185 and the metal plate options enable distinct glove forming effects, wherein the baseball provides a curved shape and the metal plate provides a flatter profile. In another embodiment, the interchangeable press head 145 further comprises a rounded nut or tip (not shown) comprised of metal or plastic, thereby enabling additional shaping capabilities. The interchangeable press head 145 is formed from a material selected from the group comprising metal, plastic, and a combination thereof.

According to an embodiment, a pneumatic foot pedal valve (not shown), is operably connected to the pneumatic reciprocating platen press 135 for actuating the press 135. The pneumatic foot pedal valve (not shown) is configured to cause the upper platen 142 to converge and apply pressure to the glove 10 when depressed and to cause the upper platen 142 to retract when released, thereby allowing the user to easily position and reposition the glove hands-free.

In some embodiments, the glove break-in apparatus 100 is coated with a durable powder coating finish. The compact size and ease of use make the apparatus simple to operate.

With reference to the operation of the invention, the glove 10 is positioned on the adjustable round base 130 with the glove pad 190 disposed beneath. The adjustable round base 130 is rotated and vertically adjusted as needed to properly position the glove 10. The interchangeable press head 145, such as the baseball 185, is coupled to the upper platen 140.

In one embodiment, the glove break-in apparatus 100 is designed to be compact and lightweight, weighing less than 50 pounds, enabling easy transport and use in various settings such as homes, sporting goods stores, and even on the field. The apparatus is powered entirely by compressed air from an external air compressor, eliminating the need for electrical power on the chassis. The efficiency of the glove break-in apparatus 100 is remarkable, as it can achieve a 76% to 90% break-in level within 10 to 20 minutes, significantly reducing the time and effort required compared to traditional methods that can take days or even weeks to achieve a 50% to 60% break-in level. This rapid break-in capability has the potential to revolutionize the industry by providing a fast, consistent, and accessible solution for breaking in gloves.

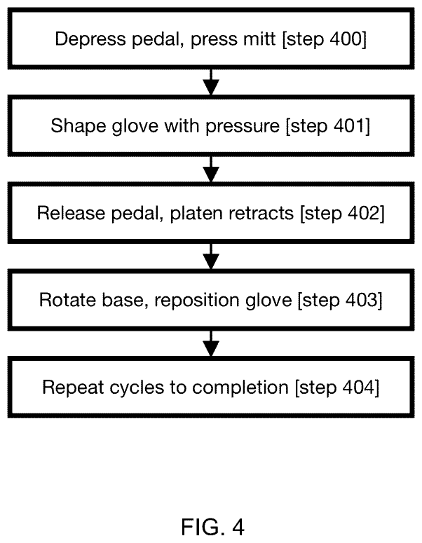

FIG. 4 depicts flow diagram detailing the operation of the glove break in apparatus 100. The operational steps are as follows:
[step 400] The pneumatic foot pedal valve 150 is depressed, thereby causing the upper platen 142 to converge toward the adjustable round base 130 and press the interchangeable press head 145 into the mitt pocket 12 of the glove 10 with focused pressure. Applying pressure to the mitt pocket helps shape this key area.
[step 401] The pressure applied by the interchangeable press head 145 imparts a desired shape to the glove 10, wherein the baseball 185 imparts a curved pocket shape.
[step 402] The pneumatic foot pedal valve 150 is released, thereby causing the upper platen 142 to retract.
[step 403] The adjustable round base 130 may be rotated and re-positioned repeatedly to work different areas of the glove 10, such as a thumb or finger stalls, thereby creating a game-ready fold.
[step 404] Multiple cycles of depressing and releasing the pneumatic foot pedal valve 150 may be performed to complete the glove break-in process.

In some embodiments the apparatus can successfully break in multiple gloves, up to 6 gloves in 1.5 hours, thereby demonstrating its practical utility and time-saving abilities compared to manual techniques. In some embodiments, the apparatus can make a glove game-ready in 5 minutes.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An apparatus for breaking in a baseball or softball glove, comprising:
a. a chassis formed from tubular metal;
b. a glove forming assembly mounted to the chassis, the glove forming assembly comprising:
i. an adjustable round base configured to receive and position a glove;
ii. a pneumatic reciprocating platen press installed on top of the chassis and positioned above the glove forming assembly, wherein the pneumatic press comprises:
1. an upper platen configured to converge vertically toward the adjustable round base and apply pressure to the glove when the press is actuated, wherein the upper platen includes an interchangeable press head adapted to impart a desired shape to the glove; and
c. a pneumatic foot pedal valve operably connected to the pneumatic reciprocating platen press for actuating the press, the foot pedal valve configured to cause the upper platen to converge and apply pressure to the glove when depressed and to cause the upper platen to retract when released.

2. The apparatus of claim 1, wherein the interchangeable press head comprises a baseball configured to impart a curved shape to the glove.

3. The apparatus of claim 1, wherein the interchangeable press head comprises a metal plate configured to impart a flattened shape to the glove.

4. The apparatus of claim 1, wherein the interchangeable press head is formed from a material selected from a group comprising: metal, plastic, nylon, rubber, composite, and combinations thereof.

5. The apparatus of claim 1, wherein the interchangeable press head further comprises a tip selected from a group comprising: a rounded metal tip, a flat metal tip, a rounded nylon tip, a flat nylon tip, a rounded rubber tip, a flat rubber tip, a rounded composite tip, and a flat composite tip.

6. The apparatus of claim 1, wherein the interchangeable press head comprises a baseball attachment.

7. The apparatus of claim 1, wherein the adjustable round base is configured to rotate up to about 4-5 inches to accommodate different sizes and shapes of gloves.

8. The apparatus of claim 1, wherein the pneumatic reciprocating platen press is configured to operate with a 120V air compressor.

9. The apparatus of claim 1, wherein the apparatus is coated with a powder coating.

10. The apparatus of claim 1, further comprising a glove pad positionable on the adjustable round base and configured to support the glove during the breaking-in process.

11. The apparatus of claim 1, wherein the tubular metal of the chassis is selected from a group comprising aluminum and steel.

12. A glove break-in apparatus, comprising:
a. a metal chassis;
b. a glove forming assembly affixed to the chassis, the glove forming assembly comprising a circular base that is rotatable and adjustable vertically up to accommodate different glove sizes and enable positioning of different areas of a glove;
c. a pneumatic reciprocating platen press mounted on the chassis above the glove forming assembly, the pneumatic press having an upper platen that travels vertically to converge toward and apply a compressive force to a glove positioned on the circular base when the press is activated, the upper platen including an interchangeable tip that contacts the glove and is selected from a group comprising:
i. a rounded metal tip,
ii. a rounded plastic tip, and
iii. a baseball;
d. a 2-position, 4-way pneumatic foot pedal valve connected to the pneumatic reciprocating platen press via fittings and tubes, the foot pedal valve configured to activate the pneumatic press, causing the upper platen to converge and apply the compressive force when the foot pedal is depressed, and to cause the upper platen to release and travel upward when the foot pedal is released; and
e. a connector for attaching an air compressor hose to power the pneumatic reciprocating platen press, wherein the apparatus is configured to be powered by an air compressor.

13. The glove break-in apparatus of claim 12, further comprising a glove pad positionable on the circular base and configured to support the glove during a break-in process.

14. The glove break-in apparatus of claim 12, wherein the metal chassis is formed from a metal selected from a group comprising aluminum and steel.

15. The glove break-in apparatus of claim 12, wherein the interchangeable tip comprises a baseball configured to impart a pocket shape to the glove.

16. The glove break-in apparatus of claim 12, wherein the circular base is rotatable up to about 4-5 inches to accommodate different sizes and shapes of gloves.

17. The glove break-in apparatus of claim 12, wherein the interchangeable tip comprises a rounded metal or plastic tip configured to apply a uniform compressive force to the glove.

18. The glove break-in apparatus of claim 12, wherein the pneumatic reciprocating platen press is configured to operate with a 120V air compressor.

19. The glove break-in apparatus of claim 12, wherein the powder coating on the metal chassis is selected from the group consisting of: a polyester powder coating, a polyurethane powder coating, and an epoxy powder coating.
